(19) United States
(12) Patent Application Publication
(10) Pub. No.: US 2024/0027937 A1
(43) Pub. Date: Jan. 25, 2024

(54) SHUTTER LOCKING STRUCTURE FOR DEVELOPMENT CARTRIDGE

(71) Applicant: Hewlett-Packard Development Company, L.P., Spring, TX (US)

(72) Inventors: Jin-Hong Kim, Seongnam-si (KR); SUNGJIN KIM, Seongnam-si (KR); Seongwoong Yang, Seongnam-si (KR); Youngkwang Shin, Seongnam-si (KR); Seung-Chan Park, Seongnam-si (KR)

(73) Assignee: Hewlett-Packard Development Company, L.P., Spring, TX (US)

(21) Appl. No.: 18/110,797

(22) Filed: Feb. 16, 2023

(30) Foreign Application Priority Data
Jul. 19, 2022 (KR) 10-2022-0088954

(51) Int. Cl. G03G 15/08

(52) U.S. Cl. CPC G03G 15/0886; G03G 2215/0692

(57) ABSTRACT

An example development cartridge includes a shutter switchable between a closing position and an opening position to open and close a toner inlet through which a toner may be received, and a locking member switchable between a locking position to lock the shutter at the closing position and an unlocking position to allow the shutter to be opened.

### CROSS-REFERENCE TO RELATED PATENT APPLICATIONS

This application claims priority to South Korea Patent Application No. 10-2022-0088954, filed on Jul. 19, 2022, the entirety of which is incorporated by reference herein.

### BACKGROUND

An image forming apparatus using an electrophotographic method is to supply toner to an electrostatic latent image formed on a photoconductor to form a visible toner image on the photoconductor, transfer the toner image through an intermediate transfer medium or directly to a print medium, and fuse the transferred toner image onto the print medium.

A development cartridge may form a visible toner image by supplying toner to an electrostatic latent image formed on a photoconductor. The development cartridge may include a toner inlet for supplementing toner. Based on the development cartridge reaching an end of the life thereof, the development cartridge may be removed from a main body of the image forming apparatus and a new process cartridge may be mounted on the main body. The process cartridge may include a photoconductive unit including a photoconductive drum and a development unit including a development roller. The development roller may be located separately from the photoconductive drum by a development gap.

### BRIEF DESCRIPTION OF THE DRAWINGS

Various examples will be described below by referring to the following figures.

FIG. 1 is a schematic partial exploded perspective view of a development cartridge according to an example;

FIG. 2 is a schematic side view of a state wherein a shutter is located at a closing position according to an example;

FIG. 3 is a schematic side view of a state wherein a shutter is located at an opening position according to an example;

FIG. 4 is a front view of a development cartridge viewed in a mounting direction, showing an arrangement state of a locking member according to an example;

FIG. 5 is a schematic cross-sectional view around a toner inlet according to an example;

FIG. 6 shows a state wherein a locking member is located in a rear end portion of a safe section according to an example;

FIG. 7 shows a state wherein a shutter is unlocked according to an example;

FIG. 8 shows a state wherein a shutter is opened by a first guide portion of a locking member moved to a second unlocking position according to an example;

FIG. 9 shows a state wherein a locking protrusion is in contact with a second guide portion in a case where a locking member is returned to a locking position from a second unlocking position according to an example;

FIG. 10 shows a state wherein a shutter is closed by a second guide portion of a locking member returned to a locking position according to an example;

FIG. 11 is a schematic side view of a locking member according to an example;

FIGS. 12 to 14 show an interference structure between a first interference portion and a locking member according to an example; and

FIG. 15 is a schematic structural diagram of an image forming apparatus according to an example.

### DETAILED DESCRIPTION

Hereinafter, various examples will be described with reference to the drawings. Like reference numerals in the specification and the drawings denote like elements, and thus a redundant description may be omitted.

An electrophotographic image forming apparatus may include a development cartridge to form a toner image onto a photoconductor, e.g., a photoconductive drum. A toner may be supplied from a toner cartridge to the development cartridge. The development cartridge may include a toner inlet to which toner supplied from the toner cartridge may be introduced. The development cartridge may be mounted on or removed from a main body of the image forming apparatus. Based on the development cartridge being removed from the main body, toner may leak outside the development cartridge through the toner inlet or a foreign substance may be introduced to the development cartridge through the toner inlet. In this regard, a shutter may be provided in the development cartridge to open or close the toner inlet.

The shutter may include a cap to close the toner inlet. In this case, based on the cap being removed before the development cartridge is mounted on the main body, in a situation in which the development cartridge is removed from the main body, the cap is to be mounted again on the toner inlet, degrading user convenience. For example, the shutter may be structured to be movable between a position to close the toner inlet and a position to open the toner let. The shutter may be elastically biased in a direction of the position to close the toner inlet by an elastic member. The development cartridge may be distributed as a consumable separately from an image forming apparatus, and the shutter may be partially opened by a shock, vibration, etc., in a distribution process such that toner inside the development cartridge may leak outside. As an elastic force of the elastic member decreases, the operating reliability of the shutter may degrade. Moreover, considering the magnitude of the elastic force of the elastic member, a design for securing the structural stability of the shutter, a structure for supporting the shutter, etc., may be involved.

Examples of the disclosure may include a development cartridge having a shutter that is capable of closing and opening a toner inlet, and an image forming apparatus employing the development cartridge. Examples of the disclosure may include a development cartridge having a shutter that is easy to open, and an image forming apparatus employing the development cartridge. Examples of the disclosure may include a development cartridge having improved user convenience, and an image forming apparatus employing the development cartridge.

An example of a development cartridge according to the disclosure may include a locking member to switch between a locking position, to lock a shutter at a closing position to close a toner inlet, and an unlocking position, to allow the shutter to switch to an opening position to open the toner inlet. With this structure, the shutter may be locked at the closing position by the locking member, making it possible to prevent the shutter from being unintentionally opened and thus preventing toner from leaking or a foreign substance from being introduced into the development cartridge due to the unintentional opening. For example, the shutter may be rotated between the closing position and the opening position. For instance, the locking member may be linearly moved to switch between the locking position and the unlocking position. The locking member may be elastically biased to the locking position by an elastic member.

For example, the shutter may be opened and closed by being rotated with respect to a hinge. The shutter may include a first locking portion. The locking member may include a second locking portion that restricts the first locking portion to prevent the shutter from being rotated at the locking position. For example, the first locking portion may include a locking protrusion that is offset from the hinge. The second locking portion may include a locking groove that restricts the locking protrusion. The locking groove may have a safe section that temporarily restricts the locking protrusion based on the locking member switching between the locking position and the unlocking position. By providing the safe section, movement of the locking member due to an external shock and unintentional unlocking of the shutter caused by the movement may be reduced or prevented. The first locking portion may have a groove shape, and the second locking portion may have a protrusion shape.

For example, an elastic sealing member may be arranged between the shutter and the toner inlet. The elastic sealing member may close a gap between the shutter and the toner inlet by being elastically compressed between the toner inlet and the shutter, based on the shutter being closed. Based on the locking member being located at the locking position, a space between the first locking portion and the second locking portion, e.g., the locking protrusion and the locking groove, may be smaller than the amount of compression of the elastic sealing member. Thus, it is possible to prevent occurrence of the gap between the shutter and the toner inlet due to the space between the locking protrusion and the locking groove.

For example, based on the locking member switching to a second unlocking position beyond the unlocking position from the locking position, the locking member may interfere with the shutter to rotate the shutter to the opening position. For example, the locking member may include a first guide portion to interfere with the first locking portion, e.g., the locking protrusion, to rotate the shutter to the opening position based on the locking member switching between the locking position and the second unlocking position. For example, based on the locking member switching to the locking position from the second unlocking position, the locking member may interfere with the shutter to rotate the shutter to the closing position. For example, the locking member may include a second guide portion to interfere with the first locking portion, e.g., the locking protrusion, to rotate the shutter to the closing position based on the locking member switching to the locking position from the second unlocking position.

The image forming apparatus according to an example may include a main body including a toner storage unit and a first interference portion and the development cartridge that may be mounted on and removed from the main body. For example, the shutter may be rotated between the closing position and the opening position around the hinge to open the toner inlet. Based on the development cartridge being mounted on the main body, the locking member may interfere with the first interference portion to be moved to the unlocking position to allow the shutter to be opened from the locking position for locking the shutter at the closing position. For example, the locking member may be moved between the locking position and the unlocking position by being moved in a mounting/removal direction of the development cartridge.

For example, the locking member may include a coupling portion. Based on the development cartridge being mounted on the main body, the first interference portion may be locked by the coupling portion in a direction to move the locking member between the locking position and the unlocking position. Based on the development cartridge being removed from the main body, the first interference portion may be locked by the coupling portion in a direction to move the locking member from the unlocking position to the locking position. The second interference portion having this shape may have a structure including, for example, an elastic arm.

Hereinbelow, examples of a development cartridge and an image forming apparatus will be described with reference to the drawings. In the drawings, like reference numerals denote like components, and sizes and thicknesses of components may be exaggerated for clarity of explanation.

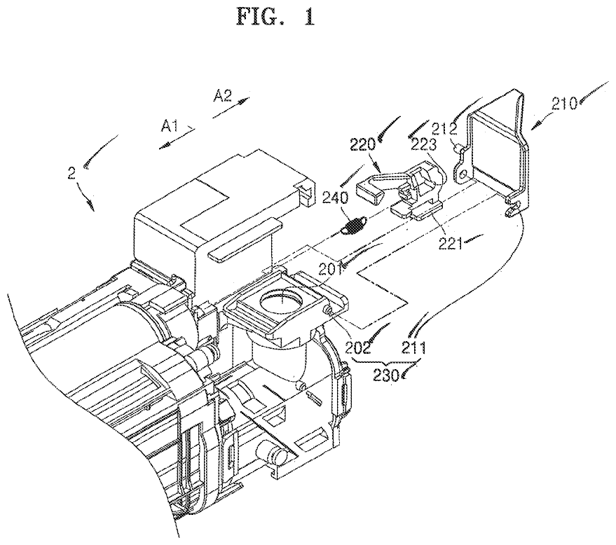

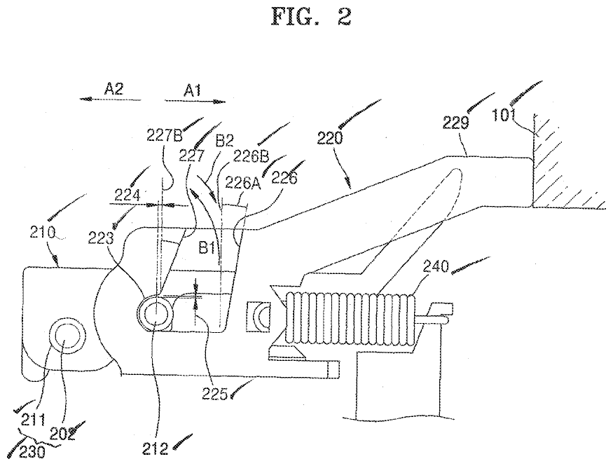

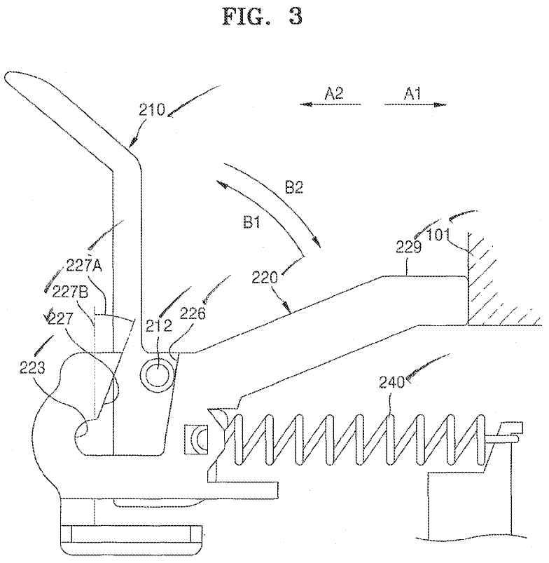

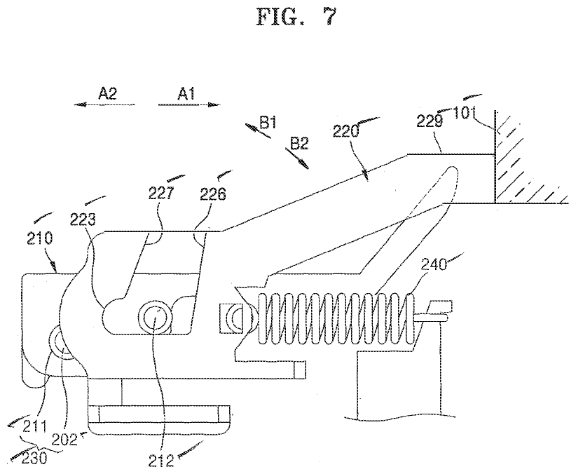

FIG. 1 is a schematic partial exploded perspective view of a development cartridge 2 according to an example. FIG. 2 is a schematic side view of a state wherein a shutter 210 is located at a closing position according to an example. FIG. 3 is a schematic side view of a state wherein the shutter 210 is located at an opening position according to an example. Referring to FIGS. 1 to 3, the development cartridge 2 may include a toner inlet 201 into which toner may be introduced. The shutter 210 is to open or close the toner inlet 201 and a locking member 220 is to selectively lock the shutter 210. The shutter 210 may switch between a closing position (FIG. 2) and an opening position (FIG. 3) to close and open the toner inlet 201. The locking member 220 may switch between a locking position (FIG. 2) that locks the shutter 210 at the closing position and an unlocking position for allowing the shutter 210 to be opened. The unlocking position of the locking member 220 is a position where the shutter 210 may be rotated to the opening position as the shutter 210 is unlocked as shown in FIG. 7 described below. The position of the locking member 220 shown in FIG. 3 may be a position where the locking member 220 is moved further beyond the unlocking position, and may be the second unlocking position where the locking member 220 is further moved to locate the shutter 210 at the opening position as described below.

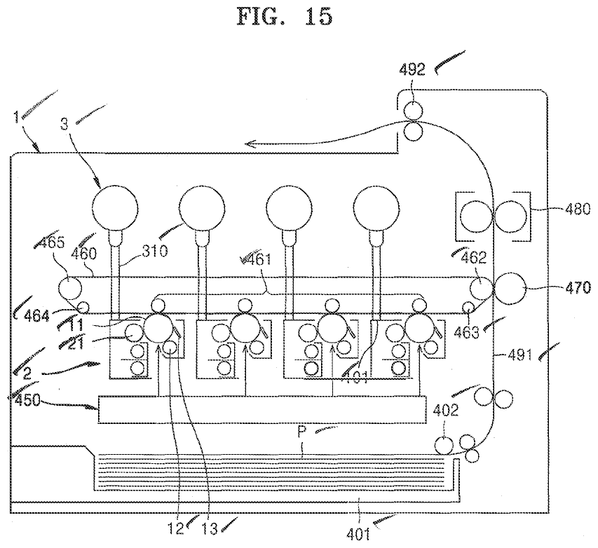

The development cartridge 2 may be mounted on and removed from a main body 1 of an image forming apparatus as shown in FIG. 15 described below. The development cartridge 2 may slide, for example, in a mounting direction A1, to be mounted on the main body 1 and may slide in a removal direction A2 that is opposite to the mounting direction A1, to be removed from the main body 1. The development cartridge 2 may be an integral development cartridge including a photoconductor where an electrostatic latent image may be formed, e.g., a photoconductive drum (not shown), and a development roller (not shown) to supply a toner to the electrostatic latent image for development. The integral development cartridge 2 may also be referred to as a ‘process cartridge’ or an ‘imaging cartridge’. The development cartridge 2 may include a development roller. In this case, the development cartridge 2 may be mounted on or removed from the main body 1 separately from a photoconductor cartridge including a photoconductor on which an electrostatic latent image may be formed, e.g., a photoconductive drum (not shown). The development cartridge 2 of the current example may be an integral development cartridge. The mounting direction A1 and the removal direction A2 may be an axial direction of the photoconductive drum or the development roller.

Inside the development cartridge 2, a developer, e.g., a toner and a carrier may be accommodated. Based on the development cartridge 2 being mounted on the main body 1, the development cartridge 2 may be supplied with the toner from a toner storage unit 3 of FIG. 15 provided in the main body 1, e.g., a toner cartridge. To this end, the toner inlet 201 may be provided in the development cartridge 2. For example, with respect to a state where the development cartridge 2 is mounted on the main body 1, the toner inlet 201 may be opened upwardly in an upper portion of the development cartridge 2. A toner supply line 310 of FIG. 15 may be provided between the toner cartridge and the toner inlet 201. Based on the development cartridge 2 being mounted on the main body 1, the toner inlet 201 may be connected to a supply side end of the toner supply line 310.

The development cartridge 2, as a consumable replaced at the end of a life thereof, may be distributed separately from the image forming apparatus. The development cartridge 2 may be separated from the main body 1 for maintenance, etc., during the use thereof. Based on the development cartridge 2 being separated from the main body 1, the toner may leak through the toner inlet 201 or a foreign substance may be introduced into the development cartridge 2 through the toner inlet 201. The shutter 210 may open and close the toner inlet 201. Based on the development cartridge 2 being mounted on the main body 1, the shutter 210 may be located at an opening position for opening the toner inlet 201 to supply the toner from the toner cartridge to the development cartridge 2. Based on the development cartridge 2 being removed from the main body 1, the shutter 210 may be located at the closing position for closing the toner inlet 201.

For example, the shutter 210 may be rotated between the opening position and the closing position. As an example, the shutter 210 may be rotated around a hinge 230 to switch between the closing position and the opening position. The hinge 230 may include a hinge shaft 202 and a hinge hole 211. For example, the hinge shaft 202 may be provided in the development cartridge 2 and the hinge hole 211 rotatably coupled to the hinge shaft 202 may be provided in the shutter 210. The shutter 210 may be rotated up and down to switch between the opening position and the closing position.

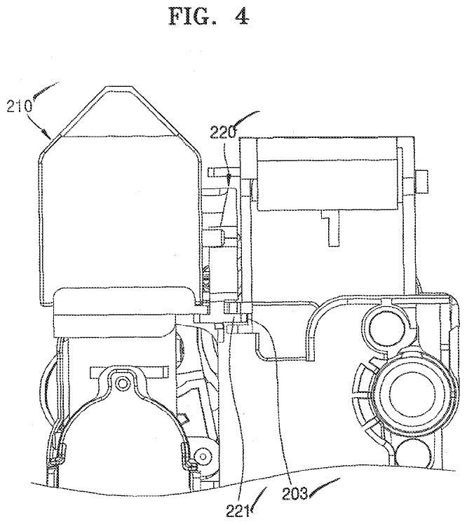

The locking member 220 may be, for example, linearly moved to switch between the locking position and the unlocking position. Moving directions of the locking member 220 may include the mounting direction A1 and the removal direction A2. For example, the locking member 220 may slide in the removal direction A2 to be moved between the locking position and the unlocking position. The locking member 220 may slide in the mounting direction A1 to be moved between the unlocking position and the locking position. FIG. 4 is a front view of the development cartridge 2 viewed in the mounting direction A1, showing an arrangement state of the locking member 220 according to an example. Referring to FIGS. 1 and 4, a first rail 203 extending in the mounting direction A1 may be provided on the development cartridge 2. The locking member 220 may include a second rail 221 supported on the first rail 203 to slide in the mounting direction A1 and the removal direction A2.

Referring to FIG. 2, the shutter 210 may be located at the closing position for closing the toner inlet 201. The locking member 220 may be located at the locking position for closing the shutter 210 at the closing position. The shutter 210 may include the first locking portion. The locking member 220 may include the second locking portion that restricts the first locking portion to prevent the shutter 210 from being rotated at the locking position. For example, the first locking portion may include a locking protrusion 212 that is offset from the hinge 230, e.g., the hinge hole 211. The second locking portion may include a locking groove 223 that restricts the locking protrusion 212. Based on the shutter 210 being located at the closing position and the locking member 220 being located at the locking position, the locking protrusion 212 may be inserted into the locking groove 223. The locking groove 223 may restrict the locking protrusion 212 so as for the shutter 210 not to be rotated from the closing position to the opening position, i.e., in a direction B1 in FIG. 2. Thus, the shutter 210 may be locked at the closing position. The development cartridge 2 shown in FIG. 2 may be in a state of being removed from, e.g., the main body 1 of the image forming apparatus. The shutter 210 in a state of being located at the closing position may be mechanically locked by the locking member 220, thus being stably maintained at the closing position. Hence, the toner inside the development cartridge 2 may be prevented from leaking outside through the toner inlet 201, i.e., toner leakage may be prevented. In addition, a foreign substance may be prevented from being introduced into the development cartridge 2 through the toner inlet 201.

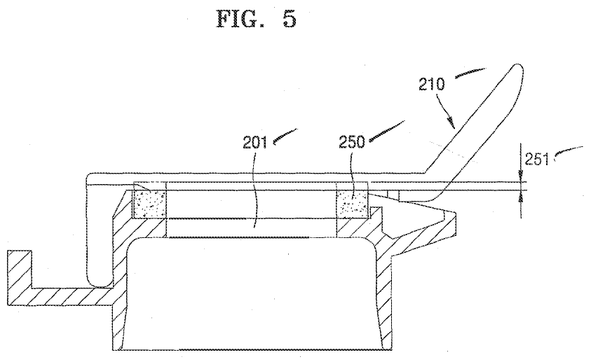

FIG. 5 is a schematic cross-sectional view around the toner inlet 201 according to an example. Referring to FIG. 5, an elastic sealing member 250 may be arranged between the toner inlet 201 and the shutter 210. The elastic sealing member 250 may surround the toner inlet 201. Based on the shutter 210 being closed, the elastic sealing member 250 may be elastically compressed between the toner inlet 201 and the shutter 210 to close a gap between the shutter 210 and the toner inlet 201. The elastic sealing member 250 may be formed of, for example, an elastic sponge, rubber, etc. In FIG. 5, a dotted line indicates a state before the elastic sealing member 250 is compressed, and a solid line indicates a state after the elastic sealing member 250 is compressed. A compressive amount 251 is a space between the dotted line and the solid line.

Based on the locking member 220 being located at the locking position, there may be a space 225 of FIG. 2, e.g., a gap, between the first locking portion and the second locking portion, e.g., the locking protrusion 212 and the locking groove 223. The space 225 of FIG. 2 may have a negative influence on stably maintaining the shutter 210 at the closing position. In this regard, the space (i.e., gap) 225 between the first locking portion and the second locking portion, e.g., the locking protrusion 212 and the locking groove 223 may be less than the compressive amount 251 of FIG. 5 of the elastic sealing member 250 corresponding to the state where the shutter 210 is located at the closing position. Thus, a gap between the shutter 210 and the toner inlet 201 may be prevented from occurring due to the space (i.e., gap) 225 between the locking protrusion 212 and the locking groove 223.

Referring to FIGS. 1 to 3, the development cartridge 2 may include an elastic member 240. The elastic member 240 may apply an elastic force to the locking member 220 in a direction to locate the locking member 220 at the locking position. For example, the elastic member 240 may apply an elastic force to the locking member 220 in a direction to move the locking member 220 in the mounting direction A1. The elastic member 240 may be implemented by, for example, a tension coil spring having an end portion and another end portion respectively connected to the locking member 220 and the development cartridge 2. The elastic member 240 may not be limited to a shape shown in FIGS. 1 to 3, and the elastic member 240 may have various shapes capable of elastically biasing the locking member 220 to locate the locking member 220 at the locking position. By the elastic member 240, the locking member 220 may be stably maintained at the locking position and the shutter 210 may be stably maintained at the closing position.

As described above, the development cartridge 2 may be distributed separately from the main body 1 of the image forming apparatus. In the distribution process, a greater shock than the elastic force of the elastic member 240 may be applied to the development cartridge 2. Based on the locking member 220 being slightly moved by the shock from the locking position to the unlocking position, e.g., in the removal direction A2, the shutter 210 may be temporarily unlocked, temporarily causing a gap between the shutter 210 and the toner inlet 201. The toner may leak outside through the gap that is temporarily caused. Referring to FIG. 2, according to the development cartridge 2 of an example, the second locking portion, e.g., the locking groove 223 may have a safe section 224 that temporarily restricts the first locking portion, e.g., the locking protrusion 212, based on the locking member 220 switching between the unlocking position and the locking position. Based on a moving amount of the locking member 220 in the removal direction A2 being less than a length of the safe section 224, locking of the shutter 210 by the locking member 220 may not be released. As the safe section 224 is provided, it is possible to reduce or prevent temporary unlocking of the shutter 210 due to the movement of the locking member 220 caused by an external shock, and a possibility of leakage of the toner due to the temporary unlocking of the shutter 210.

The development cartridge 2 may slide, e.g., in the mounting direction A1, to be mounted on the main body 1 of the image forming apparatus. As the development cartridge 2 slides in the mounting direction A1, the locking member 220 may interfere with a first interference portion 101 provided in the main body 1 to be moved in the removal direction A2. The locking member 220 may be moved in the removal direction A2 to switch to the unlocking position. For example, an interference lever 229 may be provided in the locking member 220. Based on the development cartridge 2 sliding in the mounting direction A1, the interference lever 229 of the locking member 220 may interfere with the first interference portion 101. As the development cartridge 2 slides in the mounting direction A1, the locking member 220 may be relatively moved in the removal direction A2. Based on the moving amount of the locking member 220 in the removal direction A2 being greater than the length of the safe section 224, the first locking portion, e.g., the locking protrusion 212 may leave the second locking portion, e.g., the locking groove 223. The locking member 220 may be located at the unlocking position. The shutter 210 may enter a state of being rotated between the closing position and the opening position, i.e., in the direction B1 in FIG. 3. For example, the shutter 210 may interfere with the second interference portion (not shown) provided in the main body 1 to be rotated with respect to the hinge 230 in the direction B1. The locking member 220 may be pushed by the first interference portion 101 to be continuously moved in the removal direction A2. Based on the development cartridge 2 reaching a mounting position of the main body 1, the shutter 210 may be located at the opening position as shown in FIG. 3. The locking member 220 may be further moved in the removal direction A2 to reach the second unlocking position. A supply end portion of the toner supply line 310 may be coupled to the toner inlet 201, and the toner may be supplied to the development cartridge 2 from the toner storage unit 3, e.g., the toner cartridge.

For example, based on the locking member 220 switching between the second unlocking position and the unlocking position, the locking member 220 may interfere with the shutter 210 to rotate the shutter 210 to the opening position. For example, referring to FIGS. 2 and 3, the locking member 220 may include a first guide portion 226 to rotate the shutter 210 to the opening position by interfering with the first locking portion, e.g., the locking protrusion 212, based on the locking member 220 switching between the unlocking position and the second unlocking position. Based on the locking member 220 being moved between the unlocking position and the second unlocking position, the first guide portion 226 may push the first locking portion, e.g., the locking protrusion 212 to rotate the shutter 210 between the closing position and the opening position, e.g., in the direction B1. The first guide portion 226 may be implemented by, for example, a slope inclined with respect to a line 226B perpendicular to the moving direction of the locking member 220 in the direction B2 opposite to an open direction B1 of the shutter 210. An angle 226A between the line 226B and the first guide portion 226 may be selected such that the shutter 210 is pushed by the first guide portion 226 to be naturally rotated between the closing position and the opening position.

For example, based on the locking member 220 switching between the locking position and the second unlocking position, the locking member 220 may interfere with the shutter 210 to rotate the shutter 210 to the closing position. For example, referring to FIGS. 2 and 3, the locking member 220 may include a second guide portion 227 to rotate the shutter 210 to the closing position by interfering with the first locking portion, e.g., the locking protrusion 212, based on the locking member 220 switching between the second unlocking position and the locking position. Based on the locking member 220 being moved between the second unlocking position and the locking position, the second guide portion 227 may push the first locking portion, e.g., the locking protrusion 212 to rotate the shutter 210 between the opening position and the closing position, e.g., in the direction B2. The second guide portion 227 may have a shape to push the locking protrusion 212, for example, downwardly. The second guide portion 227 may be implemented by, for example, a slope inclined with respect to a line 227B perpendicular to the moving direction of the locking member 220 in the closing direction B2 of the shutter 210. An angle 227A between the line 227B and the second guide portion 227 may be selected such that the shutter 210 may be pushed by the second guide portion 227 to be naturally rotated between the opening position and the closing position.

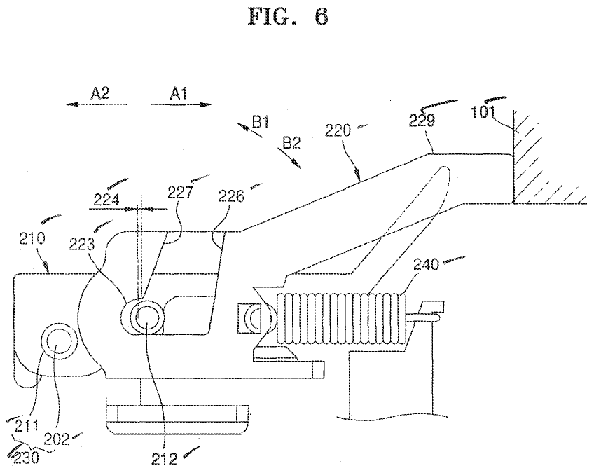

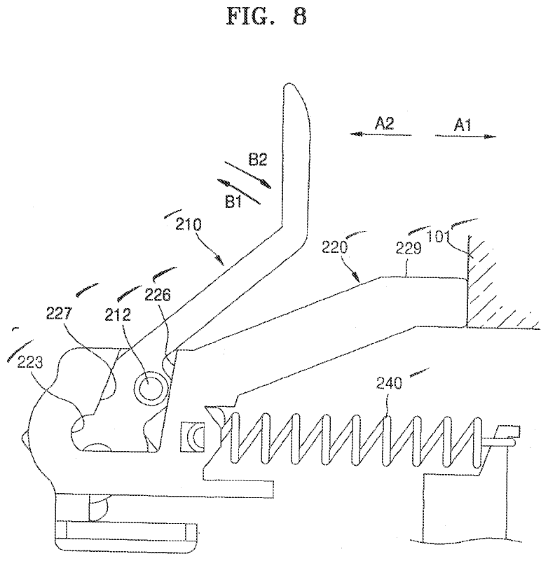

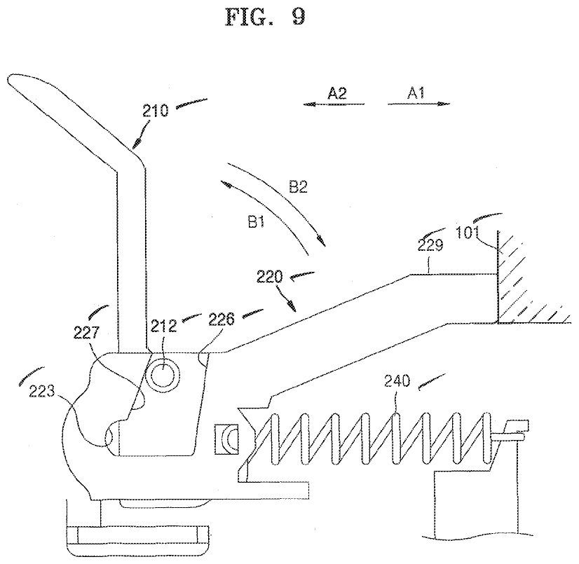

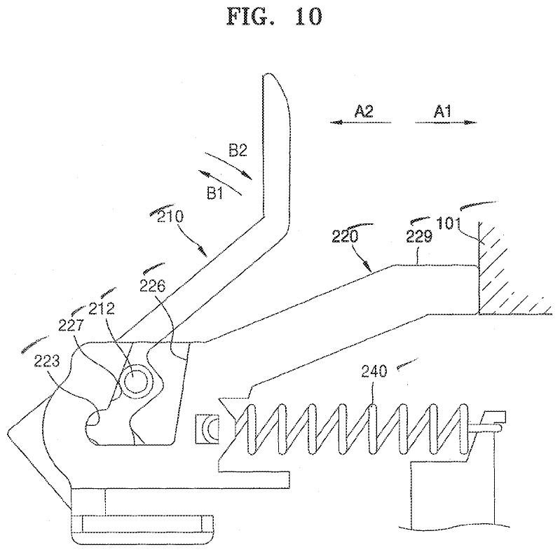

FIG. 6 shows a state wherein the locking member 220 is located in a rear end portion of the safe section 224 according to an example. FIG. 7 shows a state wherein the shutter 210 is unlocked according to an example. FIG. 8 shows a state wherein the shutter 210 is opened by the first guide portion 226 of the locking member 220 moved to the second unlocking position according to an example. FIG. 9 shows a state wherein the locking protrusion 212 is in contact with the second guide portion 227 based on the locking member 220 being returned to the locking position from the second unlocking position according to an example. FIG. 10 shows a state wherein the shutter 210 is closed by the second guide portion 227 of the locking member 220 returned to the locking position according to an example. Referring to FIGS. 2, 3, 6, and 10, an example of open/closing operations of the shutter 210 will be described.

Referring to FIG. 2, in a state where the development cartridge 2 is removed from the main body 1, the shutter 210 may be located at the closing position and the locking member 220 may be located at the locking position. The locking protrusion 212 may be restricted in the locking groove 223. The shutter 210 may not be rotated in the direction B1 and locked at the closing position. By the elastic force of the elastic member 240, the locking member 220 may be maintained at the locking position and the shutter 210 may be stably maintained locked at the closing position. Moreover, as shown in FIGS. 2 and 5, the gap 225 between the locking protrusion 212 and the locking groove 223 may be less than the compressive amount 251 of the elastic sealing member 250. Thus, leakage of the toner inside the development cartridge 2 outside through the toner inlet 201, i.e., toner leakage, may be prevented, and introduction of the foreign substance into the development cartridge 2 through the toner inlet 201 may also be prevented.

The development cartridge 2 may slide in the mounting direction A1 to be mounted on the main body 1. Based on the development cartridge 2 sliding to some degree in the mounting direction A1, the first interference portion 101 of the main body 1 may contact the interference lever 229 of the locking member 220. As the development cartridge 2 continues sliding in the mounting direction A1, the locking member 220 may be relatively moved in the removal direction A2. As shown in FIG. 6, until the locking member 220 is located in the rear end portion of the safe section 224, the locking protrusion 212 may be maintained to be restricted by the locking groove 223 and the safe section 224. Thus, the shutter 210 may not be rotated in the direction B1 and may be maintained closed.

Based on the development cartridge 2 further sliding in the mounting direction A1 in the state shown in FIG. 6, the locking member 220 reaches the unlocking position as shown in FIG. 7. The locking protrusion 212 may leave the locking groove 223 and the safe section 224. The shutter 210 may be unlocked and enter a state of being rotatable in the direction B1.

Based on the development cartridge 2 further sliding in the mounting direction A1 in the state shown in FIG. 7, the first guide portion 226 of the locking member 220 may contact the locking protrusion 212. Based on the development cartridge 2 further sliding in the mounting direction A1 in the state shown in FIG. 7, the second interference portion (not shown) provided on the main body 1 may push the shutter 210 to initially rotate the shutter 210 slightly in the direction B1, after which the first guide portion 226 of the locking member 220 may contact the locking protrusion 212. As the development cartridge 2 slides in the mounting direction A1, the first guide portion 226 pushes the locking protrusion 212 to rotate the shutter 210 in the direction B1 as shown in FIG. 8.

Based on the development cartridge 2 reaching the mounting position in the main body 1, the shutter 210 may reach the opening position as shown in FIG. 3. The locking member 220 may reach the second unlocking position. The supply end portion of the toner supply line 310 may be coupled to the toner inlet 201, and toner may be supplied to the development cartridge 2 from the toner storage unit 3, e.g., the toner cartridge.

To remove the development cartridge 2 from the main body 1, the development cartridge 2 may be caused to slide in the removal direction A2 in the state shown in FIG. 3. The locking member 220 may be moved relative to the development cartridge 2 in the mounting direction A1 by the elastic force of the elastic member 240. As shown in FIG. 9, the second guide portion 227 of the locking member 220 may contact the locking protrusion 212 of the shutter 210 located at the opening position. As the development cartridge 2 slides in the removal direction A2, the second guide portion 227 of the locking member 220 moved in the mounting direction A1 by the elastic force of the elastic member 240 may push the locking protrusion 212 to rotate the shutter 210 in the direction B2 as shown in FIG. 10. Upon removal of the development cartridge 2, the shutter 210 may reach the closing position and the locking member 220 may reach the locking position as shown in FIG. 2. The first locking portion, e.g., the locking protrusion 212 may be restricted by the second locking protrusion, e.g., the locking groove 223, and the shutter 210 may be locked at the closing position. As the elastic sealing member 250 is compressed between the shutter 210 and the toner inlet 201, the gap between the shutter 210 and the toner inlet 201 may be sealed.

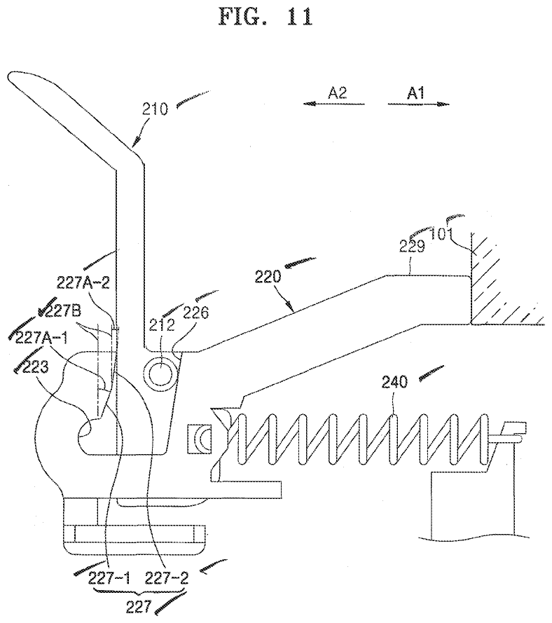

Although the second guide portion 227 has one slope in the aforementioned examples of the disclosure, the second guide portion 227 may have various shapes. FIG. 11 is a schematic side view of the locking member 220 according to an example. Referring to FIG. 11, the second guide portion 227 may be implemented by two slopes 227-1 and 227-2 that are inclined with respect to the line 227B perpendicular to the moving direction of the locking member 220 in the closing direction B2 of the shutter 210. For example, the first slope 227-1 located adjacent to the locking groove 223 may have a first angle 227A-1 with respect to the line 227B, and the second slope 227-2 located apart from the locking groove 223 may have a second angle 227A-2 with respect to the line 227B. The first angle 227A-1 may be greater than the second angle 227A-2.

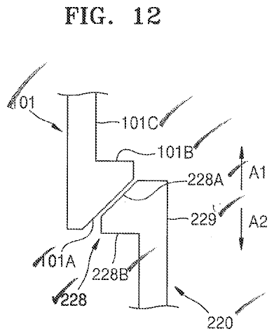

FIGS. 12 to 14 show an interference structure between the first interference portion 101 and the locking member 220 according to an example. Referring to FIG. 12, the locking member 220 may include a coupling portion 228. The first interference portion 101 may be locked in the coupling portion 228 in a direction to move the locking member 220 between the unlocking position or the second unlocking position and the locking position based on the development cartridge 2 being mounted on the main body 1. The first interference portion 101 may be locked in the coupling portion 228 in a direction to move the locking member 220 between the locking position and the second unlocking position or the unlocking position based on the development cartridge 2 being removed from the main body 1. The first interference portion having this shape may have a structure including, for example, an elastic arm 101C. For example, the coupling portion 228 may include first and second coupling portions 228A and 228B provided on an end portion of the interference lever 229. The first interference portion 101 may include the elastic arm 101C and third and fourth coupling portions 101A and 101B provided on an end portion of the elastic arm 101C. The first coupling portion 228A and the third coupling portion 101A may have the shape of slopes inclined with respect to the mounting direction A1. According to the first interference portion 101 and the coupling portion 228 having such shapes, the elastic member 240 may be omitted.

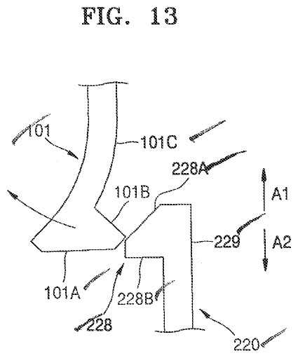

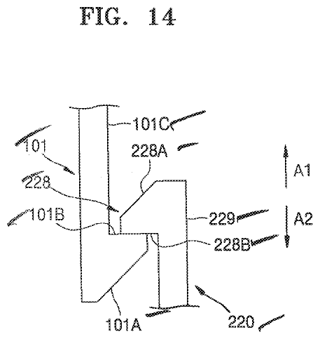

Based on the development cartridge 2 being mounted on the main body 1, the first coupling portion 228A and the third coupling portion 101A may be locked to each other as shown in FIG. 12. The third coupling portion 101A may be located in a side in the mounting direction A1 with respect to the first coupling portion 228A. Based on the development cartridge 2 sliding in the mounting direction A1, the third coupling portion 101A may push the first coupling portion 228A in the removal direction A2. Thus, the locking member 220 may be moved in the removal direction A2. Based on the locking member 220 reaching the second unlocking position, the locking member 220 may be locked by a stopper that is not shown and may not be moved any longer in the removal direction A2. Based on the development cartridge 2 sliding further in the mounting direction A1, the elastic arm 101C may be elastically bent as shown in FIG. 13 such that the third coupling portion 101A leaves the first coupling portion 228A. Once mounting of the development cartridge 2 is completed, locking between the first coupling portion 228A and the third coupling portion 101A may be terminated. As the elastic arm 101C elastically returns to the original state, the fourth coupling portion 101B may be locked by the second coupling portion 228B as shown in FIG. 14. The fourth coupling portion 101B may be located in a side in the removal direction A2 with respect to the second coupling portion 228B.

As the fourth coupling portion 101B may be locked by the second coupling portion 228B, the locking member 220 may be relatively moved in the mounting direction A1 with respect to the development cartridge 2 as the development cartridge 2 slides in the removal direction A2 with respect to the main body 1. Based on the locking member 220 reaching the locking position, the locking member 220 may be locked by the stopper that is not shown, and thus may not be moved further in the mounting direction A1. Based on the development cartridge 2 sliding further in the removal direction A2, the elastic arm 101C may be elastically bent as shown in FIG. 13. Once removal of the development cartridge 2 is completed, locking between the second coupling portion 228B and the fourth coupling portion 101B may be terminated. As the elastic arm 101C is elastically returned to the original state, the first coupling portion 228A and the third coupling portion 101A may be locked to each other.

FIG. 15 is a schematic structural diagram of an image forming apparatus according to an example. Referring to FIG. 15, the image forming apparatus may include the main body 1 and the development cartridge 2. The main body 1 may include an exposure 450, an intermediate transfer belt 460, a transfer roller 470, and a fuser 480. A plurality of development cartridges 2 may include four development cartridges 2 to form a toner image in colors of yellow (Y), magenta (M), cyan (C), and black (K). In the four development cartridges 2, developers in colors of C, M, Y, and K, e.g., toners and carriers may be respectively received. The development cartridge 2 may include a photoconductive drum 11 on a surface of which an electrostatic latent image may be formed, and a development roller 21. The development cartridge 2 may develop the electrostatic latent image into a visible toner image by supplying the toner to the electrostatic latent image.

A charging roller 12 may charge the photoconductive drum 11 to have a uniform surface electric potential. The exposure 450 may irradiate light modulated corresponding to image information to the photoconductive drum 11 to form an electrostatic latent image on the photoconductive drum 11. The development roller 21 may supply the toner received in the development cartridge 2 to a development gap opposing the photoconductive drum 11. The toner may be supplied to the electrostatic latent image across the development gap by a developing bias voltage applied to the development roller 21, such that the electrostatic latent image may be developed into the visible toner image. The intermediate transfer belt 460 may be circularly driven by being supported by a plurality of support rollers 462, 463, 464, and 465. Four intermediate transfer rollers 461 may be arranged at positions facing the photoconductive drum 11 of the four development cartridges 2 with the intermediate transfer belt 460 therebetween. The toner image developed on the photoconductive drum 11 may be intermediately transferred to the intermediate transfer belt 460 by an intermediate transfer bias voltage applied to the intermediate transfer roller 461. A cleaning blade 13 may remove a developer remaining on the surface of the photoconductive drum 11 after an intermediate transfer process. The transfer roller 470 may be located facing the intermediate transfer belt 460 to form a transfer nip. A print medium P may be picked up by a pickup roller 402 from a feeding cassette 401 and fed to the transfer nip along a path 491. By the transfer bias voltage applied to the transfer roller 470, the toner image on the intermediate transfer belt 460 may be transferred to the print medium P. The fuser 480 may fuse the toner image transferred to the print medium P onto the print medium P by applying heat and pressure to the toner image. The print medium P on which printing is completed may be discharged by a discharge roller 492.

The main body 1 may include the toner storage unit 3 and the first interference portion 101. In the four toner storage units 3, e.g., toner cartridges, toners in colors of Y, M, C, and K may be respectively received. Hereinbelow, the toner storage unit 3 will be referred to as a toner cartridge 3. The toners in colors of Y, M, C, and K may be respectively supplied to four development cartridges 2 from the four toner cartridges 3. For example, an end portion of the toner supply line 310 may be connected to the toner cartridge 3, and the other end portion thereof, e.g., a supply end portion may be connected to the toner inlet 201 of the development cartridge 2.

The plurality of development cartridges 2 may be mounted on and removed from the main body 1. Although not shown in FIG. 15, the plurality of development cartridges 2 each may have an example structure described with reference to FIGS. 1 to 14. Referring to FIGS. 1 to 15, the locking member 220 may interfere with the first interference portion 101 to move between the locking position to lock the shutter 210 at the closing position and the unlocking position to allow the shutter 210 to be opened, based on the development cartridge 2 being mounted on the main body 1. As the locking member 220 is moved to the second unlocking position, the locking member 220 may interfere with the shutter 210 to rotate the shutter 210 to the opening position. Based on the development cartridge 2 being removed from the main body 1, the locking member 220 may be moved between the second unlocking position or the unlocking position and the locking position to lock the shutter 210 at the closing position by the elastic force of the elastic member 240 or interference with the first interference portion 101. As the locking member 220 is moved between the second unlocking position and the locking position, the locking member 220 may push the shutter 210 to rotate the shutter 210 to the closing position. The locking member 220 may be moved in the mounting direction A1 and the removal direction A2 of the development cartridge 2, thus being moved between the locking position and the unlocking position, and/or the second unlocking position.

Although the disclosure has been described with reference to an example shown in the drawings, it will be understood that various modifications and equivalent other examples may be made from the shown example. Therefore, the scope of the disclosure should be defined by the appended claims.

What is claimed is:

1. A development cartridge comprising:
a toner inlet to receive a toner;
a shutter switchable between a closing position and an opening position to open and close the toner inlet; and
a locking member switchable between a locking position to lock the shutter at the closing position and an unlocking position to allow the shutter to be opened.

2. The development cartridge of claim 1,
wherein the shutter is rotatable between the closing position and the opening position, and
wherein the locking member is linearly movable between the locking position and the unlocking position.

3. The development cartridge of claim 1, wherein the locking member is to interfere with the shutter to rotate the shutter to the opening position in a case where the locking member switches to a second unlocking position beyond the unlocking position.

4. The development cartridge of claim 3, wherein the locking member is to interfere with the shutter to rotate the shutter to the closing position in a case where the locking member switches to the locking position from the second unlocking position.

5. The development cartridge of claim 1, further comprising an elastic member to apply an elastic force to the locking member in a direction to locate the locking member at the locking position.

6. The development cartridge of claim 1,
wherein the shutter is rotatable around a hinge to be opened and closed,
wherein the shutter comprises a locking protrusion that is offset from the hinge,
wherein the locking member comprises a locking groove to restrict the locking protrusion to prevent the shutter from being rotated at the locking position, and
wherein the locking groove comprises a safe section to restrict the locking protrusion in a case where the locking member is moved between the locking position and the unlocking position.

7. The development cartridge of claim 6, further comprising an elastic sealing member between the shutter and the toner inlet,
wherein a space between the locking protrusion and the locking groove at the locking position is smaller than a compressive amount of the elastic sealing member.

8. The development cartridge of claim 6, wherein the locking member comprises a first guide portion to rotate the shutter to the opening position by interfering with the locking protrusion in a case where the locking member switches between the locking position and a second unlocking position beyond the unlocking position.

9. The development cartridge of claim 6, wherein the locking member comprises a second guide portion to rotate the shutter to the closing position by interfering with the locking protrusion in a case where the locking member switches between the locking position and the second unlocking position.

10. An image forming apparatus comprising:
a main body comprising a toner storage unit and a first interference portion; and
a development cartridge to be mounted on and removed from the main body,
wherein the development cartridge comprises:
a toner inlet to receive a toner from the toner storage unit;
a shutter rotatable around a hinge between a closing position and an opening position to open the toner inlet; and
a locking member movable between a locking position to lock the shutter at the closing position and an unlocking position to allow the shutter to be opened, by interfering with the first interference portion in a case where the cartridge is mounted on the main body.

11. The image forming apparatus of claim 10, wherein the locking member is movable in a mounting/removal direction of the development cartridge to be moved between the locking position and the unlocking position.

12. The image forming apparatus of claim 10, wherein the development cartridge comprises an elastic member to apply an elastic force to the locking member in a direction to locate the locking member at the locking position.

13. The image forming apparatus of claim 10,
wherein the shutter comprises a locking protrusion that is offset from the hinge,
wherein the locking member comprises a locking groove to restrict the locking protrusion to prevent the shutter from being rotated at the locking position, and
wherein the locking groove comprises a safe section to restrict the locking protrusion in a case where the locking member is moved between the locking position and the unlocking position.

14. The image forming apparatus of claim 13, further comprising an elastic sealing member between the shutter and the toner inlet,
wherein a space between the locking protrusion and the locking groove at the locking position is smaller than a compressive amount of the elastic sealing member.

15. The image forming apparatus of claim 12,
wherein the locking member comprises a coupling portion, and
wherein the first interference portion is locked by the coupling portion in a direction to move the locking member between the locking position and the unlocking position in a case where the development cartridge is mounted on the main body, and
wherein the first interference portion is locked by the coupling portion in a direction to move the locking member between the unlocking position and the locking position in a case where the development cartridge is removed from the main body
